(19) United States
(12) Patent Application Publication
(10) Pub. No.: US 2009/0254330 A1
(43) Pub. Date: Oct. 8, 2009

(54) Method and System for Simulating a Communication Network, Related Network and Computer Program Product Therefor

(76) Inventor: Paolo Goria, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/085,362

(22) PCT Filed: Nov. 24, 2005
(86) PCT No.: PCT/EP2005/012553

§ 371 Date: May 22, 2008

(51) Int. Cl. G06G 7/62

(52) U.S. Cl. 703/13

(57) ABSTRACT

A simulator for simulating provision of services to users in a communication network including network devices, includes simulation devices each representative of a corresponding one of the network devices. Simulation device includes a plurality of user-plane application modules simulating functionalities of services provided via the corresponding network device. The application modules are configured for running application programs by associating with each application program a quality of service profile. The quality profile is representative of the quality requirements of a respective service provided to at least one simulated user and includes a set of quality of service parameters. By setting different parameters, the profile defines different services.

### FIELD OF THE INVENTION

The present invention relates to techniques for simulating communication networks such as, for example, mobile cellular networks (e.g. GSM, GPRS, EDGE, UMTS) or wireless local area networks (WLANs).

The invention has been devised with particular attention paid to the possible use in assessing the Quality of Service (QoS) of the simulated network.

### DESCRIPTION OF THE RELATED ART

Simulation is an essential step in planning, designing, realising and managing communication networks, especially as regards network performance optimisation. Simulation plays an important role when a new network is planned as well as when the performance level of an already set-up network is to be updated and optimised.

A communication network, such as a radio-mobile cellular network, is said to offer Quality of Service (QoS) when it is able to properly deal with the traffic produced by different user applications in such a way as to satisfy the requests of these users. Quality of service is therefore related to the network capability of managing differently different data flows. In general, QoS must be present along the whole data flow path (end-to-end).

A number of cellular mobile network system simulators are characterized by an object architecture, such as disclosed, for example, in WO-A-02/104055. There, a communication network is described by an object architecture wherein each single object represents the model of a real network device. Such simulators include modules or devices adapted to simulate the behaviour of physical network devices.

The simulated network may correspond to various types of networks, both mobile (e.g. GSM, GPRS, UMTS, or WLAN) and fixed. In order to permit simulation of networks operating according to a plurality of different systems, the simulator architecture is configured in such a way that, at the simulation level, the physical devices in the network are arranged in:
a first set of devices (NSC, HOSTS) completely independent from the system that regulates the operation of the network; operation of the devices of this first set is thus totally independent from such a system,
a second set of devices (MSC, SGSN, GGSN) partially independent from the system considered; operation of the devices of this second set is thus identical for at least some of a plurality of systems to be simulated, and
a third set of devices (MS/UE, NodeB, RNC, BTS, BSC) dependent from the system considered; operation of the devices in this third set is therefore specific for the system considered.

The document WO-A-05/053341 describes a method for simulating a telecommunication network through objects that model respective network devices. The method in question selectively identifies at least one Quality of Service (QoS) profile and dynamically configures the objects to simulate the supply of the service corresponding to the selectively identified Quality of Service profile.

### OBJECT AND SUMMARY OF THE INVENTION

The Applicant has observed that the criteria adopted in managing the Quality of Service profiles in the prior art simulators discussed in the foregoing do not make it possible to specify more than one user application program, i.e. more than one service, for each simulated user. In fact, in such simulators, the application level is “controlled” by a traffic generator specific for each single service. Exemplary of such generators are e.g. “Funet” for e-mail (as described for example in Göetz Brasche, Bernhard Walke “Concepts, Services, and Protocols of the New GSM Phase 2+ General Packet Radio Service”, Aachen University of Technology, IEEE Communications Magazine, August 1997, pages 94-104) and “Pareto” for Web browsing (as described in TR 101 112 V3.2.0 “Universal Mobile Telecommunications System (UMTS); Selection procedures for the choice of radio transmission technologies of the UMTS: UMTS 30.03 version 3.2.0, pages 33-34).

The Applicant has noted that a further problem left unsolved by the prior art discussed in the foregoing is related to the possibility that the simulated users may use different application programs or services.

A need can exist for solutions capable of managing communication networks in a more satisfactory way as compared to the solutions according to the prior art described previously. This applies primarily to the capability of simulating communication networks such as e.g. a cellular radio-mobile network, with the ability of managing Quality of Service profiles on the basis of single user application programs.

The object of the invention is thus to provide a satisfactory response to those needs.

According to the present invention, that object is achieved by means of a method having the features set forth in the claims that follow. The invention also relates to a corresponding system (i.e. a simulator), a corresponding simulated network as well as a related computer program product, loadable in the memory of at least one computer and including software code portions for performing the steps of the method of the invention when the product is run on a computer. As used herein, reference to such a computer program product is intended to be equivalent to reference to a computer-readable medium containing instructions for controlling a computer system to coordinate the performance of the method of the invention. Reference to “at least one computer” is intended to highlight the possibility for the present invention to be implemented in a distributed/modular fashion.

The claims are an integral part of the disclosure of the invention provided herein.

A preferred embodiment of the invention is a method of simulating provision of services to users of a communication network including network devices, the method including the steps of:
providing simulation devices each representative of a corresponding one of said network devices;
providing in at least one of said simulation devices a plurality of user-plane application modules simulating functionalities of services provided via said corresponding network device; and
running on said application modules application programs by associating to each application program a quality of service profile, wherein said profile is representative of the quality requirements of a respective service provided to at least one simulated user and includes a set of quality of service parameters (QoSparams).

By setting different parameters in the respective profiles it is possible to define different services for different users.

The arrangement described herein thus overcomes the technical problems described in the foregoing by means of a simulator which:
is able to associate a “quality of service profile” to each application program defined for simulated users; such profile describes the quality of service requirements of the single service linked to the application program;
by setting up different sets of requirements for the profile, can define different services i.e. more than one application program and, therefore, a plurality of quality of service profiles for a simulated user;
simulates the different services, i.e. the different application programs, by taking into account the different quality of the service profiles; specifically, for each application program of each user, the simulator described herein manages the instauration and the maintenance of a circuit-switched (CS) and packet-switched (PS) data service on the basis of the different characteristics (i.e. different classes of service, different guaranteed bit-rates, and so on) of the defined QoS profiles.

### BRIEF DESCRIPTION OF THE ANNEXED DRAWINGS

The invention will now be described, by way of example only, with reference to the enclosed figures of drawing, wherein:

FIG. 1 illustrates an exemplary simulator architecture as described herein,

FIG. 2 illustrates an exemplary architecture of circuit-switched (CS) modules in the arrangement described herein,

FIG. 3 illustrates an exemplary architecture of packet-switched (PS) modules in the arrangement described herein,

FIG. 4 is representative of the exemplary definition of a quality of service profile for an “originated” circuit-switched (CS) call,

FIG. 5 is representative of the exemplary definition of a quality of service profile for an “originated” packet-switched (PS) call,

FIG. 6 is representative of the exemplary definition of a quality of service profile for a “terminated” circuit-switched (CS) call, and

FIG. 7 is representative of the exemplary definition of a quality of service profile for a “terminated” starting packet-switched (PS) call.

### DETAILED DESCRIPTION OF PREFERRED EMBODIMENTS OF THE INVENTION

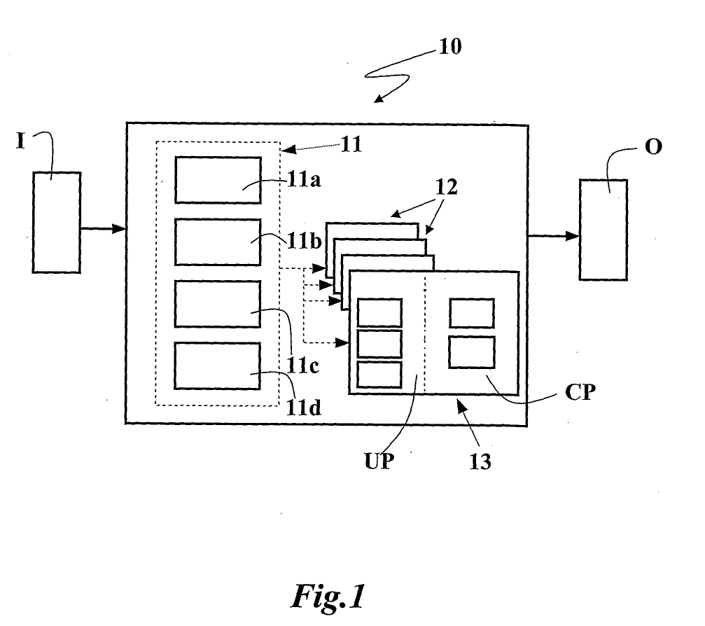

The block diagram of FIG. 1 illustrates a simulator 10 as described herein. Such a simulator can be implemented, for instance, on a computer such as a personal computer (PC) equipped with an Intel Pentium III processor and a Microsoft Windows operating system, using Microsoft Visual Study 6.0/.Net development environment and ANSI C++ programming language.

The simulator operates on a set of input signals I to produce a set of output signals O and is based on a so-called “object approach”.

The architecture of the simulator 10 thus comprises:
a simulation engine 11 responsible for the management and evolution of the simulation; and
a package device 12, including a plurality of simulation devices designated as 13, each representative of a physical device of the simulated network and the objects related to the simulation scenario.

In greater detail, the simulation engine 11 comprises the following modules:
a first module 11a, implemented for example in a similar way to the “Parameters manager” module described in WO 02/104055, which reads and interprets network configuration parameters contained in a configuration file (which represents an input to the simulator 10) and makes this information available for the creation of the simulation devices in the initialization step of the simulation;
a second module 11b, acting as an event scheduler, implemented for example in a similar way to the “Event Scheduler” module described in WO 02/104055, which establishes the sequence of execution of the simulation steps;
a third module 11c, implemented for example in a similar way to the “Factory Manager” module described in WO 02/104055, which optimizes the memory allocation of the simulation devices;
a fourth module lid, implemented for example in a similar way to the “Statistic Manager” module described in WO 02/104055, which manages modules for collecting and processing the simulation results.

Each device 13 in the package 12 comprises in turn the modules related to the different functionalities (this designation also including possible different protocols) managed by the device.

In a typical context of application in a mobile communication, the types of device 13 in the package device 12 may include:
a radio-mobile terminal MS/UE (Mobile Station/User Equipment),
node MSC (Mobile Switching Center),
node SGSN (Serving GPRS Support Node),
node GGSN (Gateway GPRS Support Node),
node NSC (Network Switching Center), and
node HOST (generic node of an IP network).

In the following, the types of devices listed in the foregoing will be briefly referred to simply as “MS/UE”, “MSC”, “SGSN”, “GGSN”, “NSC”, and “HOST” devices, respectively.

The modules comprised in each device 13 are logically partitioned in “Control-Plane” (CP) and “User-Plane” (UP) modules.

The Control-Plane modules are related to the functionalities of instauration, management, and release of the connection.

The User-Plane modules are related to the communication functionalities when the connection is active (data transmission). The User-Plane modules comprise application modules, that is modules that simulate the functionalities related to the different user level services.

The “Control-plane” modules and the “User-plane” modules used by the simulator 10 can be those related to the simulated network(s) e.g. GSM, GPRS, EDGE, UMTS or WLAN.

In particular, the “Control-plane” modules and the “User-plane” modules are organised in two families, according to the type of connection used: CS (Circuit Switched) or PS (Packet Switched).

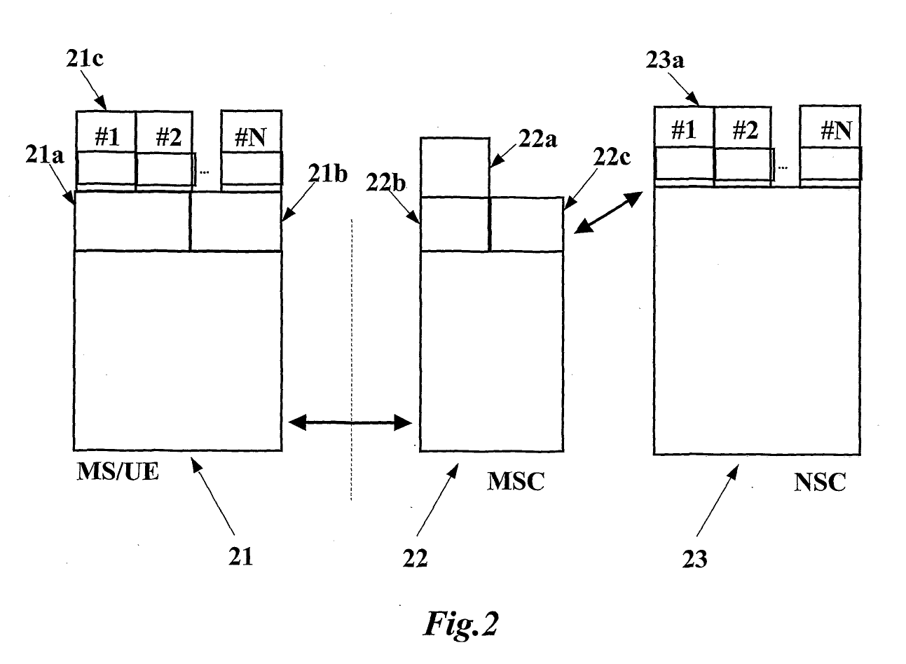

In the CS connection case (see FIG. 2), the simulator 10 uses a MT_CC module 21a (Mobile Terminal Call Control) and a MSC_CC module 22b (Mobile Switching Center Call Control), located in a MS/UE device 21 and in a MSC device 22, respectively, as well as an APP_CS module 21c (#1, #2, . . . #N) and an APP_CS module 23a (#1, #2, . . . #N) located in a MS/UE device 21 and a NSC device 23, respectively, as detailed further on in the present description.

In particular, the modules MT_CC 21a and MSC_CC 22b manage the establishment and the release of a call in the case of CS (Circuit Switched) services. During the establishment of the call, these modules communicate the type of service they request to respective modules of a radio-interface, i.e. GSM or UMTS, by indicating the related parameters.

The MSC device 22 includes a MSC_CC module 22b for each active radio-mobile terminal; the allocation of different MSC_CC modules 22b is the responsibility of an MSC_CC_Manager module 22a. The MSC_CC_Manager module 22a manages different typologies of MSC_CC modules 22b.

For each module in the simulator 10 it is thus possible to define different typologies, i.e. different “implementations” (or versions). These differ from each other for some specific functionalities, while maintaining the same communication interface, from and towards the other modules with which the module interacts.

By way of example, a simulation may involve the simulated co-existence of two groups of terminals with two different implementations (and therefore with different functionalities) of the Call Control level (CC) that includes, for example, the two MSC_CC modules in the Mobile Switching Center (MSC)— network—and the MT_CC module in the terminal.

In this case, the two modules designated MT_CC and MSC_CC are compatible with each other; in other words they belong to the same version so that compatibility is guaranteed and the functionalities of such version are executable. The role of the MSC_CC_Manager module is to assign the correct version of MSC_CC on the basis of the version of the MT_CC present in the terminal.

Conversely, a Module MSC_mM 22c represents the network portion at the MM (Mobility Management) level that manages the mobility of the terminals and the establishment of the connection for the exchange of control signals between the terminals and the network in the CS connection case.

The MS/UE device 21 comprises one or more APP_CS modules 21c (#1, #2, . . . #N) related to one or more CS application program (as an example a voice-call, a circuit switched data transfer service, a circuit switched video-call). Each APP_CS module 21c includes a data structure designated “QoSparams” corresponding to a QoS profile, i.e. to the description of the parameters related to the simulated type of service: this data structure is essentially in line with the arrangement already described in WO-A-2005/053341, thus making it unnecessary to provide a more detailed description herein.

The NSC device 23 comprises one or more APP_CS modules 23a (#1, #2, . . . #N) related to one or more CS application program; a set of APP_CS modules 23a is defined for each simulated user. In particular, each APP_CS module 23a includes a data structure indicated “QoSparams” corresponding to a Quality of Service profile, i.e. to the description of the parameters related to the type of service simulated. This data structure is again essentially in line with the arrangement already described in WO-A-2005/053341.

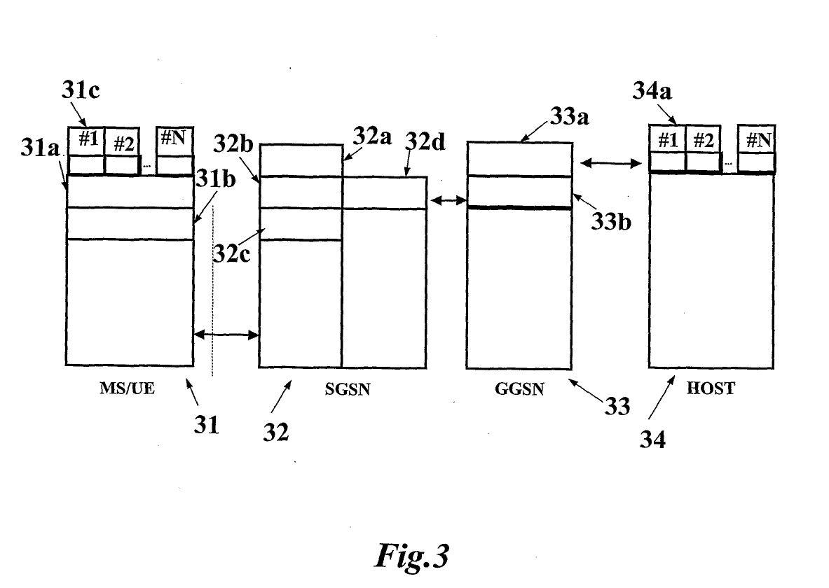

In the PS connection case (see FIG. 3), the simulator 10 uses a MT_SM module 31a (Mobile Terminal Session Management) and a SGSN_SM module 32b (Serving GPRS Support Node Session Management), located in a MS/UE device 31 and in a SGSN device 32, respectively, as well as an APP_PS module 31c (#1, #2, . . . #N) and an APP_PS module 34a (#1, #2, . . . #N) located in a MS/UE device 31 and a HOST device 34, respectively.

In particular, the modules MT_SM 31a and SGSN_SM 32b manage the establishment and the release of a call in the case of PS (Packet Switched) services. During the establishment of the call, these modules communicate the type of service they request to respective modules of a radio-interface, i.e. GSM or UMTS, by indicating the related parameters.

The MS/UE device 31 comprises one or more APP_PS modules 31c (#1, #2, . . . # N) related to one or more PS type application program (exemplary of such PS application program are: Internet surfing, downloading a file with FTP, reception of a video-stream, and so on). Each APP_PS module 31c includes a data structure indicated “QoSparams” corresponding to a Quality of Service profile. This data structure corresponds to the description of the parameters related to the type of service simulated essentially in line with the arrangement already described in WO-A-2005/053341.

The parameters taken in consideration, as defined in the 3 GPP standard (Specification TS 23.107 “Quality of Service (Qos) concept and architecture”) are the following:
Traffic class: one among four possible values CONVERSATIONAL, STREAMING, INTERACTIVE, BACKGROUND,
Transfer delay: maximum transfer time of a data-unit from the transmitter to the receiver,
Guaranteed bit-rate UL (Uplink): guaranteed transfer rate for data transmitted from the radio-mobile terminal towards the network,
Maximum bit-rate UL: maximum transfer rate for data transmitted from the radio-mobile terminal towards the network,
Guaranteed bit-rate DL (downlink): guaranteed transfer rate for data transmitted from the network towards the radio-mobile terminal, and
Maximum bit-rate DL: maximum transfer rate for data transmitted from the network towards the radio-mobile terminal.

A particular QoS profile identifies a type of service within the simulator 10.

The user of the simulator 10 can specify as input data the values of the parameters of every simulated QoS profile.

A MT_GMM module 31b is related to the portion of radio-mobile terminal at the GMM (Mobility Management) level that manages the mobility of the terminals and the establishment of the connection for the exchange of control signals between the terminals and the network in the PS connection case.

The SGSN device 32 includes a SGSN_SM module 32b for each active radio-mobile terminal; the allocation of the different SGSN_SM modules 32b is the responsibility of an SGSN_SM_Manager module 32a. The SGSN_SM_Manager module 32a manages different typologies of SGSN_SM modules 32b.

In particular, the SGSN_GTP_C module manages the transfer of the signalling of the connection (C stands for Control, e.g. Control-plane) between the SGSN module and the GGSN module, while the SGSN_GMM module is the portion of network at the GMM (Mobility Management) level that manages the mobility of the terminals and the establishment of the connection for the exchange of control signals between the terminals and the network in the PS connection case.

The HOST device 34 comprises one or more modules APP_PS 34a (#1, #2, . . . # N) related to one or more PS application programs. Each APP_PS module 34a includes a data structure indicated “QoSparams” corresponding to a Quality of Service profile, that is the description of the parameters related to the type of service simulated service (see WO-A-2005/053341 for direct reference).

Moreover, the GGSN_GTP_C module manages the transfer of the signalling of the connection (C stands for Control, e.g. Control-plane) between the GGSN module and the SGSN module (this is the counterpart of the SGSN_GTP_C module in the SGSN), while the PDP_Context_Manager module manages a PDP-Context for each service. The PDP-Context is a context where the QoS parameters of the service are stored. The module in question opens and closes the PDP-context, communicating with the SGSN_SM module through GGSN_GTP_C and SGSN_GTP_C modules.

As described previously, for each application program APP_CS 21c/23a or APP_PS 31c/34 a data structure indicated “QoSparams” is provided in the simulator 10 corresponding to a Quality of Service profile, that is the description of the parameters related to the type of simulated service.

Specifically, the data structure “QoSparams” comprises for each service various parameters related to the service, such as e.g.:
class of service (CONVERSATIONAL, STREAMING, INTERACTIVE, BACKGROUND);
guaranteed bit-rate in DL;
guaranteed bit-rate in UL;
maximum bit-rate in DL;
maximum bit-rate in UL;
maximum transfer delay.

To each simulated radio-mobile terminal MS/UE plural APP_CS/APP_PS modules can be associated with different data structures of the type designated as “QoSparams”. This makes it possible to simulate different services for every user. The simulator 10 thus makes it possible to simulate—for each user—one or more QoS profiles that are personalized and distinct from each other.

The simulator 10 manages the QoS profile for the calls “originated” from the radio-mobile MS/UE terminals and for the calls originated from the network (called “terminated”).

In the case of a call of the CS (Circuit Switched) type “originated” from the radio-mobile MS/UE terminal, the APP_CS#N module 21c sends its own “QoSparams” parameter to the MT_CC module 21a, that communicates it to the MSC_CC module 22b and to the modules related to the GSM or UMTS radio-interface that establish the connection according to the type of service indicated in “QoSparams”.

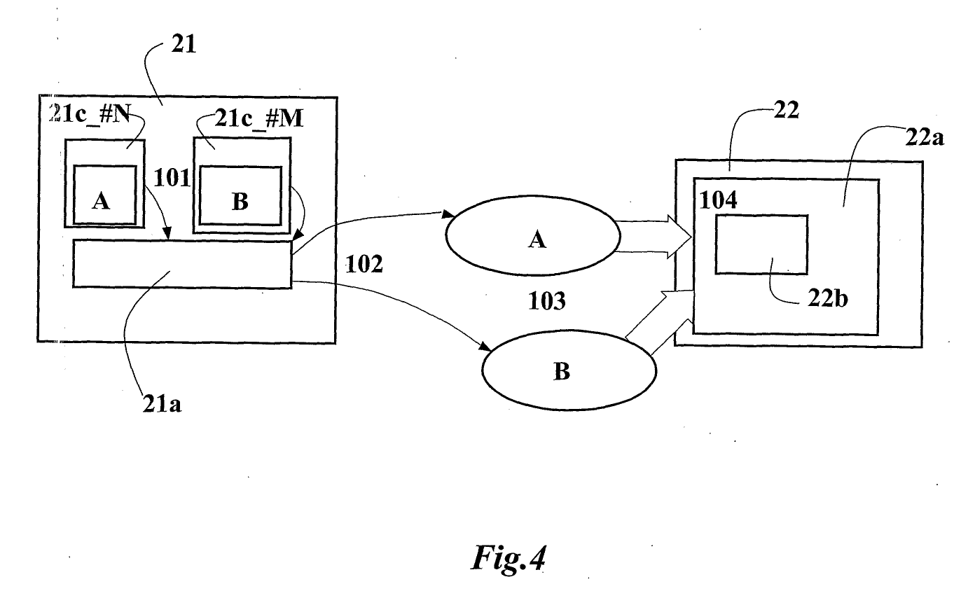

In particular, FIG. 4 illustrates the steps for managing of the QoS profile in an “originated” circuit-switched (CS) call. In a step 101, the request of establishing the connection is sent from the APP_CS module toward the MT_CC module. The request includes the “QoSparams” parameter that indicates the features of the service requested.

In a step 102, the request for establishing the connection is sent from the radio-mobile MS/UE terminal, and in particular from the APP_CS module included in the terminal, towards the network, in particular towards the MSC device. In the request for establishing the connection, the MT_CC module inserts the “QoSparams” parameter with a value equal to the “QoSparams” parameter received from the APP_CS#N module.

In a step 103, the MCS device receives the request for establishing the connection and proceeds, through the MSC_CC_Manager module, to the allocation of a MSC_CC module compatible with the version of MT_CC module in the radio-mobile MS/UE terminal.

In a step 104, the process for establishing the call proceeds by using the correct QoS profile, namely the “QoSparams” parameter.

In particular, a radio channel is assigned to the radio-mobile MS/UE terminal, according to the negotiated QoS profile; the method of allocation of the radio channel depends on the radio system used. For instance, in the case of UMTS, the MSC requests a new RAB from the RNC; in the case of GSM, the MSC requests a new channel allocation from the BSC.

In the case of a call of the PS (Packet Switched) type “originated” from radio-mobile MS/UE terminal, operation of the system is analogous to the case of the Circuit Switched (CS) originated call CS.

Specifically, the APP_PS#N module 31c sends its own “QoSparams” parameter to the MT_SM 31a module. This in turn sends the received “QoSparams” parameter toward the SGSN_SM 32b module. The SGSN_SM 32b module sends the value of “QoSparams” to the modules related to the GSM or UMTS radio-interface and establishes the connection according to the type of service indicated in “QoSparams”.

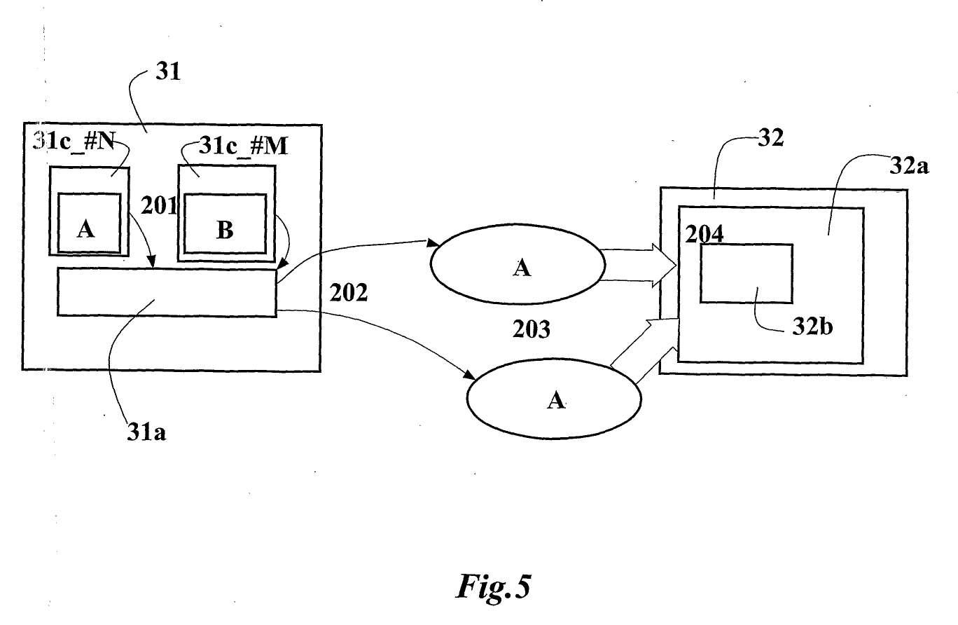

In particular, FIG. 5 illustrates the steps for managing of the QoS profile in an “originated” packet-switched (PS) call. In a step 201, the request for establishing the connection is sent from the APP_PS#N application program toward the MT_SM module. The request includes the “QoSparams” parameter(s) that indicate(s) the features of the requested service. This is essentially a set of parameters that describes requirements in terms of bit-rate, delay, class of service. In certain cases, this set may be comprised of a single parameter to indicate the service typology, such as e.g. the traffic class.

In a step 202, the request for establishing the connection is sent from radio-mobile MS/UE terminal, toward the network, in particular toward the SGSN device. The MT_SM module inserts in the request for establishing the connection the “QoSparams” parameter with value equal to the “QoSparams” parameter received from the APP_PS.

In a step 203, the SGSN device receives the request for establishing the connection and proceeds, through the SGSN_SM_Manager module, to the allocation of the SGSN_SM module related to the radio-mobile MS/UE terminal.

In a step 204, the process of establishing the call proceeds by using the correct QoS profile, namely the “QoSparams” parameter.

In particular, a radio channel is assigned to the radio-mobile MS/UE terminal, according to the negotiated QoS profile. Again the method of allocation of the radio channel depends on the radio system used. In the case of UMTS, the SGSN module requests a new RAB from the RNC; in the case of GPRS, the SGSN module sends the data to the Base Station Controller (BSC). The BSC module establishes a downlink Temporary Block Flow (TBF) to transfer the data from the network toward the terminals according to the QoS profile.

In a “terminated” call case the indication of establishment of the connection is not sent by the radio-mobile MS/UE terminal, but originates from the simulated network devices. The request for establishing the connection, therefore, comes from the APP_CS/APP_PS modules and comprises the “QoSparams” parameter to indicate the QoS profile to be used. Such a request arrives at the modules present in the MSC device 22 or the GGSN device 32.

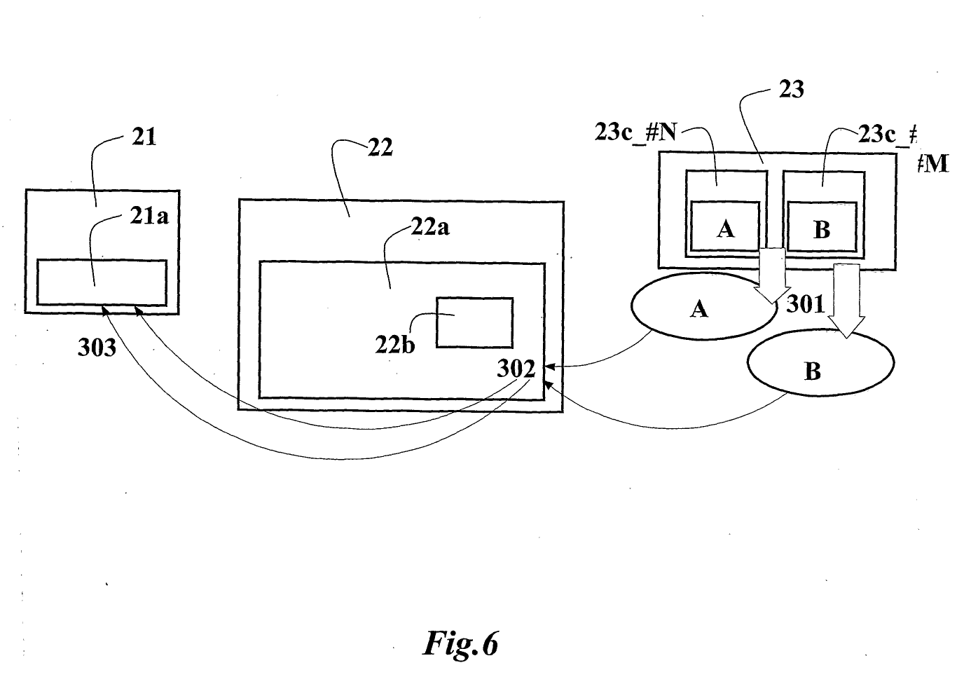

FIG. 6 illustrates the case of a “terminated” call of the Circuit-Switched (CS) type, which can be described as follows.

In a step 301, the request for establishing the connection is sent from the APP_CS#N application program, related to the i-th terminal present in the NSC device, toward the MSC device; the request includes the information identifying the radio-mobile MS/UE terminal and the “QoSparams” parameter.

In a step 302, the MSC device sends the request for establishing the connection toward the MSC_CC_Manager module in order to allocate the MSC_CC module related to the i-th radio-mobile MS/UE terminal.

In a step 303, the process of establishing the call proceeds by using the correct QoS profile, that is the “QoSparams” parameter.

In particular, the radio-mobile MS/UE terminal receives a paging message; the subsequent steps are analogous to the steps 102, 103, and 104 of the “originated” case. In other words, the radio-mobile MS/UE terminal sends a request for establishing the connection; the only difference regards the reason of the establishment.

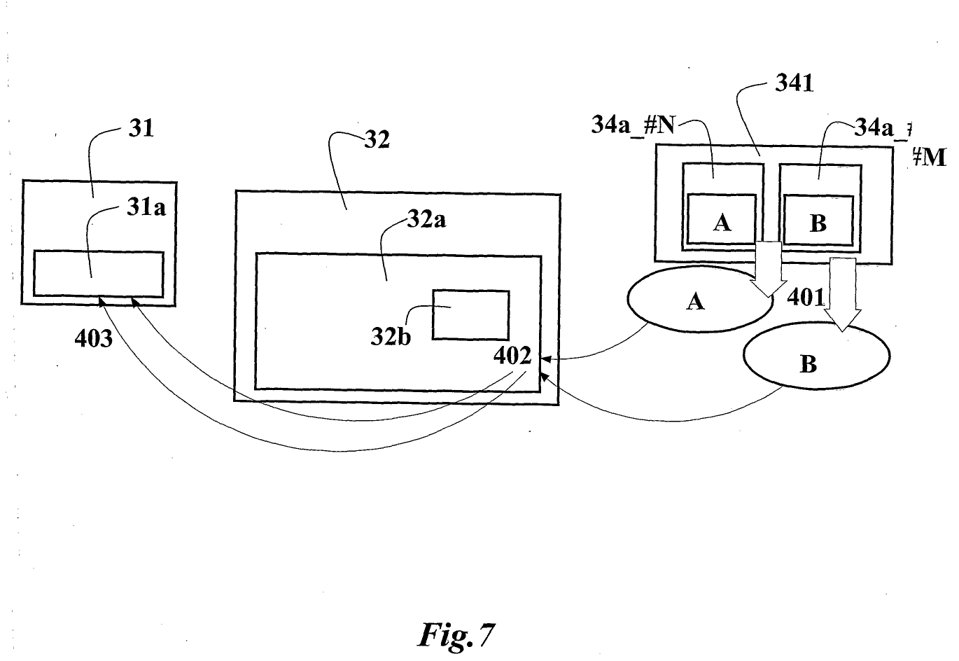

FIG. 7 illustrates the case of a “terminated” call of the Packet-Switched (PS) type, described as follows.

In a step 401 the request for establishing the connection is sent from the APP_PS#N application program related to the i-th terminal present in the HOST device toward the SGSN device. The request includes the information identifying the radio-mobile MS/UE terminal and the “QoSparams” parameter.

In a step 402, the SGSN device sends the request for establishing the connection toward the SGSN_SM_Manager module, in order to allocate the SGSN_SM module related to the i-th radio-mobile MS/UE terminal.

In a step 403, the process of establishing the call proceeds by using the correct QoS profile that is the “QoSparams” parameter.

In particular, the radio-mobile MS/UE terminal receives a paging message; the subsequent steps are analogous to the steps 202, 203, and 204 of the “originated” case. In other words, the radio-mobile MS/UE terminal sends a request for establishing the connection; the only difference regards the reason of the establishment.

The simulator 10 just described exhibits a number of advantages:
it makes it possible to define various QoS profiles for each simulated application program; consequently, simulated users can notionally use one or more application programs, and therefore one or more services, different from those services used from the other users;
when compiling the input data, the various services can be defined per user, by setting the values of the parameters of the QoS profile for each service to be simulated for each users;
management of the QoS profiles contemplates that the simulated calls are originated from mobile terminal and/or terminated from the mobile terminal;
the “QoSparams” parameter(s) that describe(s) the QoS profile is/are specified by each application program that requires the establishment of a connection. Different application programs can thus specify different “QoSparams” parameters: for the purposes of simulation, these are dealt with in a separate and distinct way, thus permitting simulation of one or more application programs for each user.

The present description focuses on the embodiment wherein for each simulation device a plurality of user-plane application modules is provided, each application module simulating the functionalities related to the different user level services.

It is to be remarked, however, that in other embodiments only a subset of the simulation devices, and even a single simulation device, can be provided with a plurality of user-plane application modules, the remaining simulation devices being provided with a single user-plane application module.

As indicated, the simulator 10 as described can be implemented with any type of computer, including personal computers equipped with standard processors (Intel, SUN, Apple) and operating system (Windows, Linux, Unix, MAC OS), by using current programming languages such as ANSI C++ (a currently preferred choice), Java, Delphi, or Visual Basic. The ANSI C++ language is a currently preferred choice in view of the good programming flexibility offered and of the high performance level, especially in terms of execution speed.

Those of skill in the art will appreciate that in the preceding description of an exemplary embodiment of the invention, the term “simulated service” essentially focuses on the action of transporting user data, without specifically considering other service steps (set-up, re-configuration, service termination, etc.) that may well affect the quality of service as perceived by users.

Focusing on the action of transporting user data is a sort of “approximation” dictated by the desire of avoiding that the description may become unduly complicated, and must not be read in a limiting sense for the invention.

Additionally, it will be appreciated that simulating multiple services in all their steps may not be practically feasible and useful; in fact, various factors (service architecture, protocols involved in the various steps, apparatus involved etc.), specific for each service, can change from implementation to implementation of the same service. Performing simulation of the particular specific implementations of each of various services may thus be hardly meaningful and the results obtained relatively poor.

Nevertheless, in those cases where these steps are meaningful in terms of QoS, the invention can be advantageously used by taking into account, on the basis of the present description, additional service steps, such as e.g. set-up, re-configuration/service termination/etc. or even just part of them.

In addition to the exemplary case of a mobile communication network (e.g. GSM, GPRS, EDGE or UMTS) considered herein the invention can be used in simulators simulating other systems such as e.g. WLAN, HSDPA, MBMS. Specifically, the invention can be used in systems for simulating telecommunication networks of the fixed or the fixed/mobile mixed type. Additionally, those of skill in the art will appreciate that the invention is in no way limited to the simulation of cellular networks: the invention can in fact be also applied to other types of network simulators based on an architecture of modules and devices mirroring real physical equipment and where the need arises of communicating the parameters related to simulated functionalities between the various modules/devices.

Consequently, without prejudice to the underlying principles of the invention, the details and the embodiments may vary, even appreciably, with reference to what has been described by way of example only, without departing from the scope of the invention as defined by the annexed claims.

1-16. (canceled)

17. A method of simulating provision of services to users of a communication network comprising network devices, comprising the steps of:
providing simulation devices, each representative of a corresponding one of said network devices;
providing in at least one of said simulation devices a plurality of user-plane application modules simulating functionalities of services provided via said corresponding network device; and
running on said application modules, application programs by associating with each application program a quality of service profile, wherein said profile is representative of quality requirements of a respective service provided to at least one simulated user and comprises a set of quality of service parameters.

18. The method of claim 17, comprising the step of running on said application modules, a plurality of application programs for said at least one simulated user, said plurality of application programs having associated therewith a respective plurality of quality of service profiles for said at least one simulated user.

19. The method of claim 17, comprising the step of providing in each said simulation device, a set of control-plane modules related to the functionalities of instauration, management, and release of connections of the corresponding network device.

20. The method of claim 19, comprising the step of providing in each said simulation device, different typologies of said user-plane modules differing from each other for at least one of said functionalities of services provided via the corresponding network device, while maintaining via said control-plane modules the same communication interface of each said simulation device with the other simulation devices of said plurality.

21. The method of claim 17, comprising the step of managing, for each said application program run for said at least one user, the instauration and the maintenance of a circuit-switched and a packet-switched data service on the basis of different quality of service profiles.

22. The method of claim 17, comprising the step of defining said quality of service profile as a function of at least one parameter selected from the group:
traffic class
maximum transfer time of a data-unit from the transmitter to the receiver,
guaranteed transfer rate for data transmitted from a terminal toward the network,
maximum transfer rate for data transmitted from a terminal toward the network,
guaranteed transfer rate for data transmitted from the network toward a terminal, and
maximum transfer rate for data transmitted from the network toward a terminal.

23. The method of claim 17, wherein said network is a mobile communication network, comprising the step of providing simulation devices representative of network devices in said network, said network devices being selected from:
a radio-mobile terminal,
a mobile switching center,
a serving GPRS support node,
a gateway GPRS support node,
a network switching center, and
a node of said network.

24. A system for simulating provision of services to users in a communication network comprising network devices, comprising: simulation devices, each representative of a corresponding device of said network devices, wherein at least one of said simulation devices comprises a plurality of user-plane application modules simulating functionalities of services provided via said corresponding network device, said application modules being configured for running application programs by associating with each application program a quality of service profile, wherein said profile is representative of quality requirements of a respective service provided to at least one simulated user and comprises a set of quality of service parameters.

25. The system of claim 24, where said application modules are configured for running a plurality of application programs for said at least one simulated user, said plurality of application programs having associated therewith, a respective plurality of quality of service profiles for said at least one simulated user.

26. The system of claim 24, wherein each said simulation device comprises a set of control-plane modules related to the functionalities of instauration, management, and release of connections of the corresponding network device.

27. The system of claim 26, wherein each said simulation device comprises different typologies of said user-plane modules differing from each other for at least one of said functionalities of services provided via the corresponding network device, while said control-plane modules comprise a same communication interface of each said simulation device with other simulation devices of said plurality.

28. The system of claim 24, wherein said simulation devices are configured for managing, for each said application program run for said at least one user, the instauration and the maintenance of a circuit-switched and a packet-switched data service on the basis of different quality of service profiles.

29. The system of claim 24, wherein said quality of service profile is defined as a function of at least one parameter selected from the group:
traffic class,
maximum transfer time of a data-unit from the transmitter to the receiver,
guaranteed transfer rate for data transmitted from a terminal toward the network,
maximum transfer rate for data transmitted from a terminal toward the network,
guaranteed transfer rate for data transmitted from the network toward a terminal, and
maximum transfer rate for data transmitted from the network toward a terminal.

30. The system of claim 24, wherein said network is a mobile communication network, comprising simulation devices representative of network devices in said network, said network devices being selected from:
a radio-mobile terminal,
a mobile switching center,
a serving GPRS support node,
a gateway GPRS support node,
a network switching center, and
a node of said network.

31. A computer program product, loadable in the memory of at least one computer and comprising software code portions capable of performing the method of claim 17.
